(19) United States
(12) Patent Application Publication
(10) Pub. No.: US 2007/0042095 A1
(43) Pub. Date: Feb. 22, 2007

(54) Method of Making Food Product and Food Product Made According to the Method

(75) Inventor: Eugene D. Gagliardi JR., Atglen, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Skippack Creek Corporation, Wilmington, DE (US)

(21) Appl. No.: 11/425,534

(22) Filed: Jun. 21, 2006

Related U.S. Application Data
(60) Provisional application No. 60/710,204, filed on Aug. 22, 2005.

(51) Int. Cl. A23B 4/20

(52) U.S. Cl. 426/332

(57) ABSTRACT

A method is provided for making a food product from a substantially solid, generally boneless muscle portion, the portion having top and bottom surfaces, first and second opposite ends and first and second lateral sides. The method comprises the steps of: making a plurality of spaced apart first cuts extending through the portion from the top surface toward but not completely to the bottom surface to establish an uncut area having a predetermined thickness proximate to the bottom surface; and making at least one second cut extending completely through the portion from the top surface to the bottom surface and generally perpendicular to at least some of the first cuts to sever from the portion at least one food product, the product including a first generally continuous edge and a plurality of strips extending outwardly from the first edge.

### CROSS REFERENCE TO RELATED APPLICATIONS

This application claims priority from U.S. Provisional Patent Application No. 60/710,204 filed Aug. 22, 2005 and entitled “Method of Making Food Product and Food Product Made According to the Method” the entire subject matter if which is hereby incorporated herein by reference.

### BACKGROUND OF THE INVENTION

The present invention relates generally to a method of making a food product and a food product made in accordance with the method and, more particularly, to a food product which includes a core area and a plurality of strips of edible material extending from the core area in a random manner.

The method of the present invention is used for making a food product from a bird, such as poultry or fowl or the like, pork, beef, or virtually any other type of meat, fish or other seafood. The present method is particularly useful in taking what would be a lower value cut of meat and turning the lower value cut into a meat product having a higher value. For example, poultry is conventionally eviscerated and dressed and sold either whole or as individual parts. One of the parts is the breast cut, which is typically marketed with the bones therein, with or without a portion of the ribs and the wings or as a boneless breast cut. In view of the increasing demand for new, innovative food products, such as boneless breasts, tenders, wings, etc., for both the commercial food market and for home use, methods for easily obtaining different types of such products have been increasingly more desirable. However, the prior art methods of producing such poultry products have not been directed to a breast cut.

The present invention comprises a method of producing a high value food product from a meat muscle, such as a breast cut of poultry, such that the food product has a core area and a plurality of strips of material formed integrally with the core area and extending outwardly therefrom in a random manner. In this manner, the consumer may readily break off the strips of material for easy, finger food consumption. The method of the present invention is relatively quick and easy to employ and results in a fun finger food product which is both appetizing and convenient for the consumer to handle.

### BRIEF SUMMARY OF THE INVENTION

Briefly stated, in one embodiment, the present invention comprises a method of making a food product from a substantially solid, generally boneless muscle portion, the portion having top and bottom surfaces, first and second opposite ends and first and second lateral sides. The method comprises the steps of: making a plurality of spaced apart first cuts extending through the portion from the top surface toward but not completely to the bottom surface to establish an uncut area having a predetermined thickness proximate to the bottom surface; and making at least one second cut extending completely through the portion from the top surface to the bottom surface and generally perpendicular to at least some of the first cuts to sever from the portion at least one food product, the product including a first generally continuous edge and a plurality of strips extending outwardly from the first edge.

In another embodiment, the present invention comprises a method of making a food product from a substantially solid, generally boneless muscle portion, the portion having top and bottom surfaces, first and second opposite ends, first and second lateral sides and a grain. The method comprises the steps of: making a plurality of generally parallel, spaced apart first cuts extending through the portion from the top surface toward but not completely to the bottom surface to establish an uncut area having a predetermined thickness proximate to the bottom surface, the first cuts being spaced apart by a first predetermined distance and extending generally parallel to the grain of the portion from the first end to the second end; and making a plurality of generally parallel, spaced apart second cuts extending completely through the portion from the top surface to the bottom surface and generally perpendicular to the first cuts and to the grain of the portion, the second cuts being spaced apart by a second predetermined distance to sever from the portion a plurality of food products, each product including a first generally continuous edge and a plurality of strips extending outwardly from the first edge.

### BRIEF DESCRIPTION OF THE SEVERAL VIEWS OF THE DRAWINGS

The foregoing summary as well as the following detailed description of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a top perspective view of a portion of a top round of beef used for illustrating the first step in the preferred embodiment of a method in accordance with the present invention;

FIG. 2 is a top perspective view of the beef portion of FIG. 1 illustrating the second step in the preferred method;

FIG. 3 is a perspective view of a beef product made in accordance with the present invention after cooking;

FIG. 4 is a perspective view of a pork product made in accordance with the present invention after cooking; and

FIG. 5 is a perspective view of a chicken breast product made in accordance with the present invention after cooking.

### DETAILED DESCRIPTION OF THE INVENTION

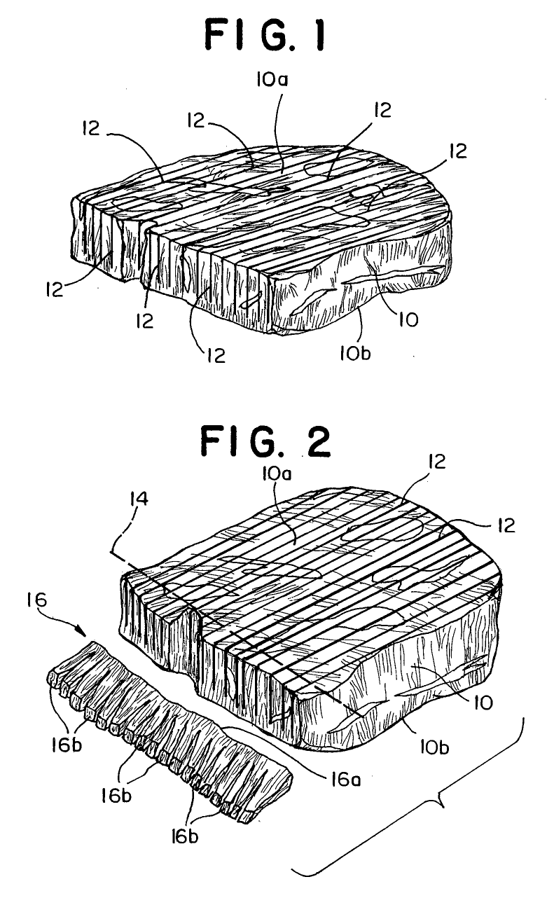

Referring to the drawings in detail, wherein like numerals indicate like elements throughout the several figures, there is shown in FIG. 1 a beef portion such as portion of a top round of beef 10 which is employed for the purpose of illustrating the preferred method of the present invention. While the method of the present invention will hereinafter be described with reference to the beef portion 10 shown in FIG. 1, it should be clearly understood by those of ordinary skill in the art that any other beef portion, for example a bottom round portion, a chuck flap portion or the like may alternatively be employed in practicing the present invention. Further, it should be understood that while the present invention is illustrated as being employed in connection with the beef portion 10 as shown, the present invention is equally applicable to other foods such as a breast or other portion of a chicken, turkey, duck, goose, or of any other poultry, fowl or the like, fish or other seafood, pork, such as a pork shoulder, Boston butt, loin, ham, etc., or virtually any other type of generally boneless, generally solid food muscle that does not have substantial connective tissue or seams therein. Accordingly, it should be clearly understood by those of ordinary skill in the art that the present invention is not limited to use with a top round beef portion 10 or with any other type of beef or other food.

Regardless of the type of food or meat which is used in connection with the method of the present invention, the food or meat is first “denuded” to remove any bone, fat, skin, connective tissue, silver, or the like so that the resulting food or meat (beef in the present embodiment) portion 10 is a substantially solid boneless muscle. Preferably, in the present embodiment, the top round beef portion 10 is in the range of about one-half inch to three inches thick, from the upper or top surface 10a to the lower or bottom surface 10b and, more preferably, is approximately one and one half inches thick. The overall size (length and width) of the beef portion 10 may vary depending on the type of meat being used. Preferably the beef portion 10 is generally squared off at least on one of the first and second ends and on the first and second lateral sides to provide a generally rectangular shaped beef portion 10 when viewed from above. However, the beef portion 10 need not be squared off and need not be rectangular shaped.

The first step in connection with the preferred method of the present invention is to make a plurality of spaced apart first elongated cuts 12 extending through the beef portion 10 from the upper or top surface 10a toward but not completely through to the bottom or lower surface 10b and extending from the first end to the second end of the beef portion 10 as shown on FIG. 1. Preferably, the first cuts 12 made partially through the beef portion 10 establish an uncut area proximate to the bottom surface 10b having a predetermined thickness of approximately one eighth of an inch to one half of an inch of the beef portion 10. More preferably one quarter of an inch of the beef portion 10 remains uncut proximate to the bottom surface 10b. Preferably, the first cuts 12 are generally parallel to each other and to at least one side of the beef portion 10 and are generally perpendicular to the upper and lower surfaces 10a and 10b of the beef portion 10. As shown in FIG. 1, preferably the first cuts 12 extend generally parallel to or “with” the grain of the beef portion 10. In the preferred embodiment, the first generally parallel cuts 12 are preferably spaced apart by a first predetermined distance, in the present embodiment about one quarter of an inch. However, it will be appreciated by those of ordinary skill in the art that the distance between the first generally parallel cuts 12 may vary and may not all be the same in some applications. The first generally parallel cuts 12 may be made utilizing a knife, water knife, saw, or any other suitable cutting device known to those skilled in the art. Preferably, the first cuts 12 are made utilizing a Bridge Con-Vey Slitter, an apparatus well known to those of ordinary skill in the meat-cutting art and available from BMC of Palmyra, N.J. The preferred Slitter (not shown) includes a plurality of individual, generally parallel cutting blades which can be adjusted to be spaced apart by a predetermined distance, in the present embodiment preferably one quarter inch. The depth of the generally parallel cutting blades of the Slitter may also be adjusted, as desired, to provide for the uncut portion having a depth or thickness of approximately one quarter of an inch proximate to the bottom surface 10b of the beef portion 10. It will be appreciated by those of ordinary skill in the art that a different cutting apparatus may alternatively be employed.

The next step in the presently preferred method is to make a plurality of second cuts 14 through the beef portion 10. As shown in FIG. 2, the second cuts 14 (only one cut 14 being shown) extend completely through the beef portion 10 from the top surface 10a to the bottom surface 10b from a first lateral side to the second lateral side of the beef portion 10 and are generally orthogonal to the generally parallel first cuts 12. The second cuts 14 are also generally parallel to each other and preferably extend generally perpendicular to or “across” the grain of the beef portion 10. Preferably, the spacing between each of the generally parallel second cuts 14 is comprised of a second predetermined distance which in the present embodiment is the same or substantially the same as the spacing between the generally parallel first cuts 12, in the present embodiment preferably about one fourth of an inch. It will be appreciated by those of ordinary skill in the art that the spacing between the generally parallel second cuts 14 may vary and may not be the same in certain applications.

The generally parallel second cuts 14 may be made utilizing a knife, water knife, saw, or other such cutting device known to those skilled in the art. Alternatively, the generally parallel second cuts 14 may be made utilizing a Bridge Con Vey Slitter as described above. However, in the case of the generally parallel second cuts 14, the depth of the blades of the Slitter is adjusted so that they cut completely through the beef portion 10. Preferably two such Slitters are utilized; a first one for making the generally parallel first cuts 12 and a second one positioned orthogonally to the first for making the generally parallel second cuts 14. If desired, a conveyor may move the beef portion 10 from the output side of the first Slitter to the input side of the second Slitter for more efficient, substantially automated production.

FIG. 2 shows a beef product 16 which is formed by employing the above-described steps in accordance with the present method. As shown, the beef product 16 includes a first generally continuous edge 16a (having a thickness corresponding to the thickness of the uncut area of the beef portion 10 proximate to the bottom surface 10b) with a plurality of attached, outwardly extending individual beef strips 16b. The beef strips 16b in the present embodiment are approximately one quarter inch on each side and have a length of approximately one and one quarter inch, assuming that the beef portion 10 has an initial thickness of one and one half inch. The beef product 16, as shown in FIG. 2, has an appearance similar to that of a comb with a base portion (continuous edge 16a) and a plurality of outwardly extending teeth (strips 16b).

The beef product 16 is further prepared with one or more seasonings, spices, flavorings or other enhancements and preferably is marinated, for example in a drum marinator, using a marinade of choice, for example a lemon garlic sauce, for adding flavor. The marinating process also causes the beef strip portions 16b to swell up slightly and keeps them at least slightly separated from each other.

After the marinating step, the beef product 16 is battered, for example by using flour or some other batter of choice and is breaded with a breading of choice, preferably utilizing a drum breader. The battering and/or breading steps could be accomplished by hand. Other equipment may be used if desired. The marinated, battered and/or breaded beef product 16 is then preferably par fried and quick frozen.

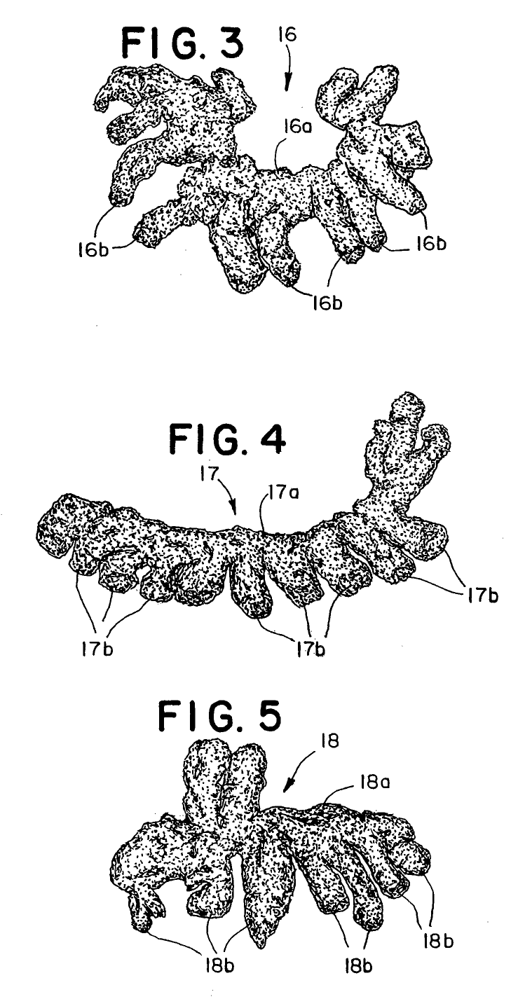

Final preparation of the beef product 16 involves heating the marinated, breaded and/or battered and frozen beef product 16 in a deep fat fryer for approximately one and one half to two minutes at approximately three hundred and fifty degrees Fahrenheit. The resulting ready to eat finger food product 16 is shown in FIG. 3. The prepared finger food beef product 16 may be picked up and eaten much like fried calamari or the like. Other methods, such as heating in a conventional oven or microwave oven may alternatively be used.

FIG. 4 illustrates a similar meat product 17 formed in substantially the same manner as described above but utilizing a pork shoulder. The pork meat product 17 includes a continuous edge 17a and a plurality of attached, outwardly extending pork strips 17b. FIG. 5 illustrates a similar meat product 18 formed in substantially the same manner as described above but utilizing a boneless chicken breast. The chicken breast product 18 includes a continuous edge 18a and a plurality of attached, outwardly extending chicken breast strips 18b. As previously stated, it will be apparent to those of ordinary skill in the art that the method of the present invention is equally applicable to virtually any other type of food such as any other type of meat, including poultry, fowl and other birds, pork, deer, fish and other seafood and the like.

From the foregoing it can be seen that the present invention comprises a method of cutting a food muscle to form a plurality of “finger food” products and the products made in accordance with the method. It will be appreciated by those skilled in the art that changes or modifications could be made to the embodiments described above without departing from the broad inventive concepts thereof. It is understood, therefore, that this invention is not limited to the particular embodiments disclosed, but it is intended to cover modifications within the spirit and scope of the present invention as defined by the appended claims.

1. A method of making a food product from a substantially solid, generally boneless muscle portion, the portion having top and bottom surfaces, first and second opposite ends and first and second lateral sides, the method comprising the steps of:
making a plurality of spaced apart first cuts extending through the portion from the top surface toward but not completely to the bottom surface to establish an uncut area having a predetermined thickness proximate to the bottom surface; and
making at least one second cut extending completely through the portion from the top surface to the bottom surface and generally perpendicular to at least some of the first cuts to sever from the portion at least one food product, the product including a first generally continuous edge and a plurality of strips extending outwardly from the first edge.

2. The method as recited in claim 1 wherein at least some of the plurality of first cuts extend from the first end to the second end of the portion and generally parallel to at least one of the lateral sides of the portion.

3. The method as recited in claim I wherein at least some of the first cuts are generally parallel to each other.

4. The method as recited in claim 1 wherein the portion includes a grain and wherein at least some of the first cuts extend generally parallel to the grain of the portion.

5. The method as recited in claim 1 wherein each of the first cuts are generally parallel to each other and are spaced apart by a first predetermined distance.

6. The method as recited in claim 5 wherein the first predetermined distance is one fourth of an inch.

7. The method as recited in claim 1 wherein the first predetermined thickness is in the range of one eighth to one half of an inch.

8. The method as recited in claim 7 wherein the predetermined thickness is one fourth of an inch.

9. The method as recited in claim 1 wherein the at least one second cut comprises a plurality of second cuts, the second cuts being generally parallel to each other and spaced apart by a second predetermined distance.

10. The method as recited in claim 9 wherein the second predetermined distance is one fourth of an inch.

11. The method as recited in claim 10 wherein the portion includes a grain and wherein the second cuts are generally perpendicular to the grain of the portion.

12. The method as recited in claim 1 further comprising the step of preparing the at least one food product by applying at least one of a seasoning, a spice, flavoring, and enhancement and a marinade.

13. The method as recited in claim 1 further comprising the step of battering and/or breading the at least one food product.

14. The method as recited in claim 13 further comprising the steps of par frying and quick freezing the food product.

15. A food product made in accordance with the method of claim 1.

16. A method of making a food product from a substantially solid, generally boneless muscle portion, the portion having top and bottom surfaces, first and second opposite ends, first and second lateral sides and a grain, the method comprising the steps of:
making a plurality of generally parallel, spaced apart first cuts extending through the portion from the top surface toward but not completely to the bottom surface to establish an uncut area having a predetermined thickness proximate to the bottom surface, the first cuts being spaced apart by a first predetermined distance and extending generally parallel to the grain of the portion from the first end to the second end; and
making a plurality of generally parallel, spaced apart second cuts extending completely through the portion from the top surface to the bottom surface and generally perpendicular to the first cuts and to the grain of the portion, the second cuts being spaced apart by a second predetermined distance to sever from the portion a plurality of food products, each product including a first generally continuous edge and a plurality of strips extending outwardly from the first edge.

17. The method as recited in claim 16 wherein the first and second predetermined distances and the predetermined thickness each comprise one fourth of an inch.

18. A food product made in accordance with the method as recited in claim 16.
